(19) United States
(12) Patent Application Publication
(10) Pub. No.: US 2026/0171686 A1
(43) Pub. Date: Jun. 18, 2026

(54) CONNECTOR

(71) Applicant: YAZAKI CORPORATION, Tokyo (JP)

(72) Inventors: Hideki MIZUNO, Kakegawa-shi (JP); Masanori NAKAMURA, Kakegawa-shi (JP); Kento TERAUCHI, Kakegawa-shi (JP); Shinichi KAMURA, Kakegawa-shi (JP)

(73) Assignee: YAZAKI CORPORATION, Tokyo (JP)

(21) Appl. No.: 19/415,135

(22) Filed: Dec. 10, 2025

(30) Foreign Application Priority Data
Dec. 18, 2024 (JP) 2024-222357

(51) Int. Cl. H01R 4/34; B60L 53/16; H01R 4/70

(52) U.S. Cl. CPC H01R 4/34; B60L 53/16; H01R 4/70; H01R 2201/26

(57) ABSTRACT

A connector includes first busbar having a first through hole through which a first fastener is configured to be inserted, a second busbar having a second through hole through which a second fastener is configured to be inserted. The first through hole has an elongated hole shape in which a hole width in a prescribed first direction is larger than a hole width in a direction intersecting the first direction, and allows a position of the first fastener in the first through hole to be adjustable in the first direction. The second through hole has an elongated hole shape in which a hole width in a prescribed second direction is larger than a hole width in a direction intersecting the second direction, and allows a position of the second fastener in the second through hole to be adjustable in the second direction.

### CROSS-REFERENCE TO RELATED APPLICATIONS

This application is based on and claims priority under 35 USC 119 from Japanese Patent Application No. 2024-222357 filed on Dec. 18, 2024, the entire content of which is incorporated herein by reference.

### TECHNICAL FIELD

The present disclosure relates to a connector including a terminal, a first busbar, a second busbar fastened and connected to the first busbar, and a housing accommodating the terminal.

### BACKGROUND ART

In the related art, a charging connector to be installed in a vehicle such as an electric vehicle or a plug-in hybrid vehicle has been proposed to supply (charge) electric power from outside the vehicle to a battery mounted on the vehicle as disclosed in, for example, JP2019-192482A.

Connectors of this type are generally required to have structures defined by various standards. For example, an interval between a plurality of terminals (so-called power terminals) provided in the connectors usually differs on a standard basis. For this reason, components of the connectors (for example, busbars to which terminals are connected) are prepared as dedicated products having different shapes or the like on a standard basis. However, in view of production cost reduction of the connectors, it is desirable to share the components of the connector as much as possible even if applied standards are different.

An object of the present disclosure is to provide a connector that can share an internal busbar even if an arrangement of a terminal differs.

To achieve the above object, the connector according to the present disclosure has following features.

### SUMMARY

A connector includes a terminal, a first busbar configured to be connected to the terminal, a first fastener configured to fasten the terminal and the first busbar, a second busbar configured to be connected to the first busbar, a second fastener configured to fasten the first busbar and the second busbar, and a housing configured to accommodate the terminal. The first busbar has a first through hole through which the first fastener is configured to be inserted. The second busbar has a second through hole through which the second fastener is configured to be inserted. The first through hole has an elongated hole shape in which a hole width in a prescribed first direction is larger than a hole width in a direction intersecting the first direction, and allows a position of the first fastener in the first through hole to be adjustable in the first direction. The second through hole has an elongated hole shape in which a hole width in a prescribed second direction is larger than a hole width in a direction intersecting the second direction, and allows a position of the second fastener in the second through hole to be adjustable in the second direction.

According to the connector of the present disclosure, the terminal and the first busbar are fastened by the first fastener, and the first busbar and the second busbar are fastened by the second fastener. The first through hole of the first busbar for inserting the first fastener has an elongated hole shape elongated in the first direction, and the second through hole of the second busbar for inserting the second fastener has an elongated hole shape elongated in the second direction. For this reason, even if the arrangement of the terminal differs depending on a standard applied to the connector, by changing the position of the first fastener in the first through hole according to the arrangement of the terminal, the terminal and the first busbar can be fastened without changing the shape of the first busbar or the position of the first busbar in the housing. Even if it is necessary to change the position of the first busbar, by changing the position of the second fastener in the second through hole according to the arrangement of the first busbar, the first busbar and the second busbar can be fastened without changing the shape of the second busbar or the position of the second busbar in the housing. Therefore, the connector of the present disclosure can share the internal busbars even if the arrangement of the terminal differs.

The present disclosure is briefly described above. Further, details of the present disclosure will be clarified by reading modes for carrying out the disclosure described below with reference to the accompanying drawings.

### BRIEF DESCRIPTION OF DRAWINGS

FIG. 1 is a perspective view of a connector according to an embodiment of the present disclosure;

FIG. 2 is an exploded perspective view of the connector illustrated in FIG. 1;

FIG. 3 is a cross-sectional view taken along a line A-A in FIG. 1;

FIG. 4 is a cross-sectional view taken along a line B-B in FIG. 1;

FIG. 5 is a rear view illustrating a state in which a second bolt is slidably held by a first busbar on a left side illustrated in FIG. 2;

FIG. 6 is a cross-sectional view taken along a line C-C in FIG. 5; and

FIG. 7 is a rear view of a second busbar illustrated in FIG. 2.

### DESCRIPTION OF EMBODIMENTS

### Embodiments

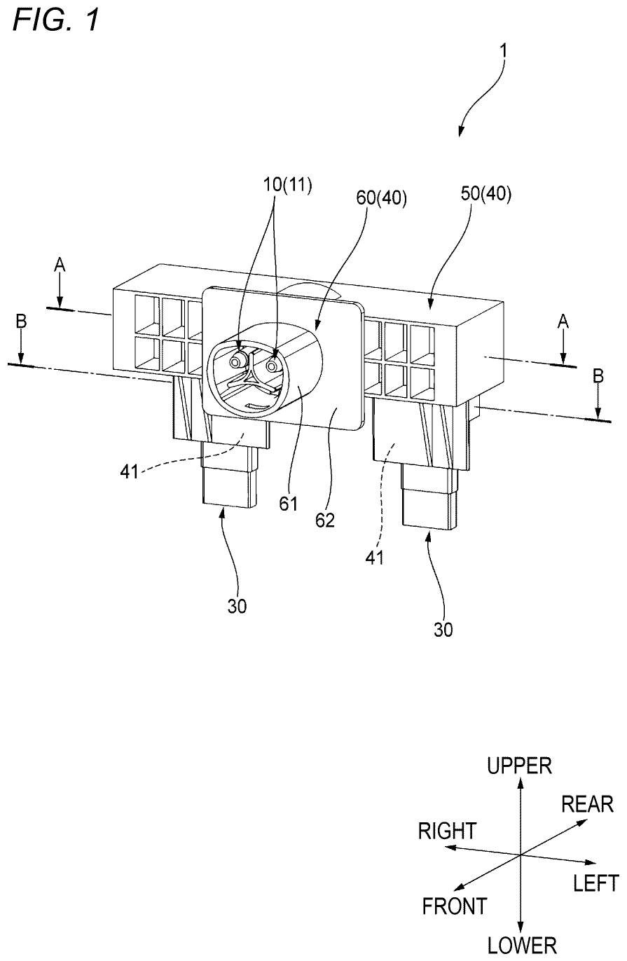

Hereinafter, a connector 1 according to an embodiment of the present disclosure will be described with reference to the drawings. The connector 1 illustrated in FIG. 1 is a charging connector (so-called charging inlet) to be installed in a vehicle such as an electric vehicle or a plug-in hybrid vehicle to supply (charge) electric power from outside the vehicle to a battery mounted on the vehicle.

Hereinafter, for convenience of description, “front”, “rear”, “upper”, “lower”, “left”, “right”, a “front-rear direction”, an “upper-lower direction”, and a “left-right direction” are defined as illustrated in FIG. 1 and the like. The “front-rear direction”, the “upper-lower direction”, and the “left-right direction” are orthogonal to one another. The left-right direction coincides with a “first direction” and a “second direction” of the present disclosure. The front-rear direction, the left-right direction, and the upper-lower direction do not necessarily have to coincide with a front-rear direction, a left-right direction, and an upper-lower direction of the vehicle or the like on which the connector 1 is mounted. Hereinafter, components constituting the connector 1 will be described in order.

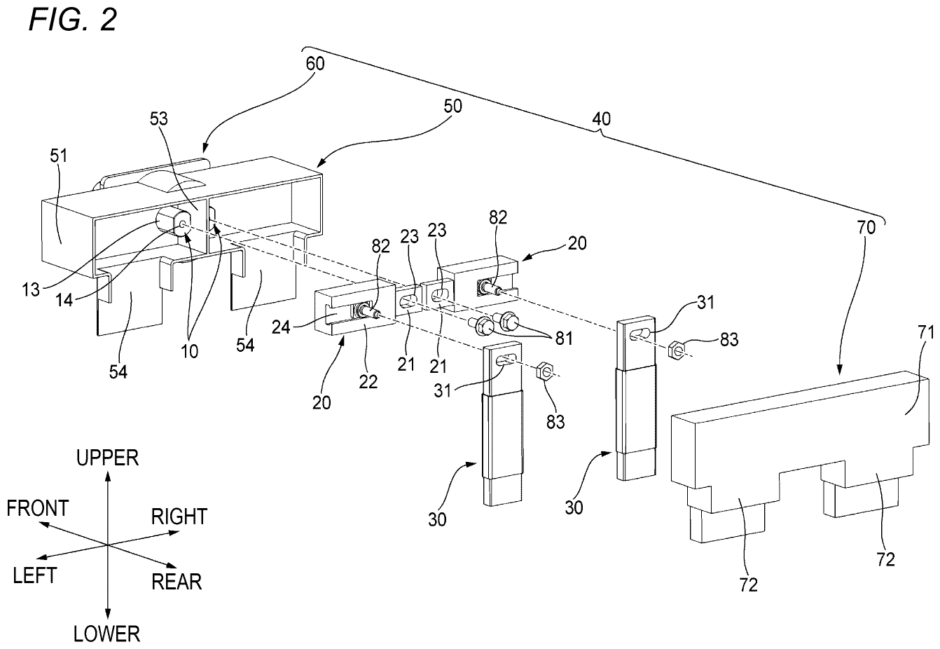

As illustrated in FIGS. 2 to 4, the connector 1 includes a pair of left and right terminals 10, a pair of left and right first busbars 20 respectively fastened to the pair of left and right terminals 10 using first bolts 81, a pair of left and right second busbars 30 respectively fastened to the pair of left and right first busbars 20 using second bolts 82, and a housing 40 accommodating the pair of left and right terminals 10. The housing 40 includes a case 50, a holder 60 assembled to the case 50, and a cover 70 assembled to the case 50. In a state in which the connector 1 is mounted on the vehicle, the terminal 10 (also referred to as a power terminal) is electrically connected to a counterpart terminal (not illustrated) belonging to a counterpart connector (for example, a so-called charging connector) to be fitted to the connector 1 during battery charging, and the second busbar 30 is electrically connected to a battery side. Hereinafter, configurations of members constituting the connector 1 will be described in order.

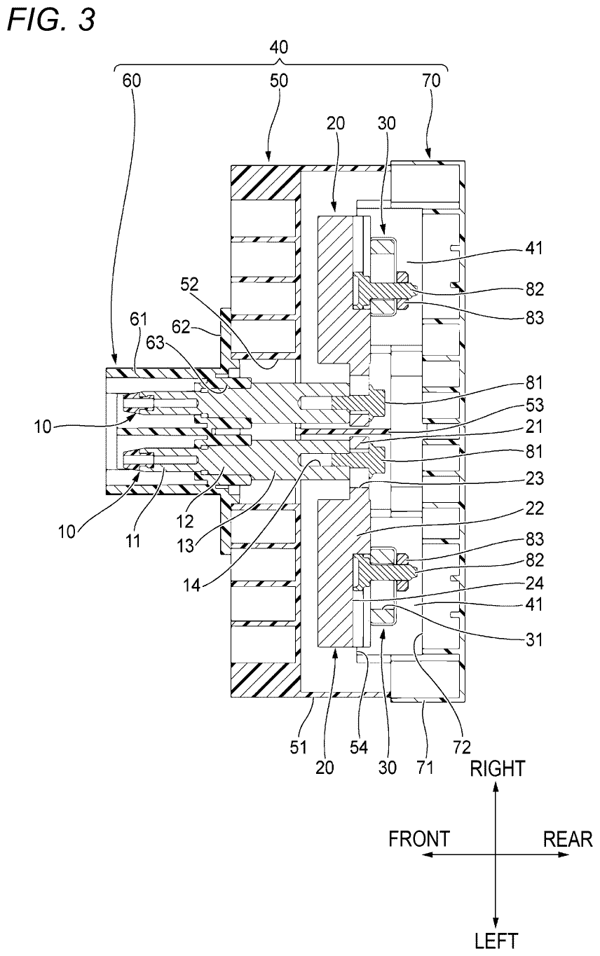

First, the terminal 10 will be described. The pair of left and right terminals 10 are held by the holder 60 constituting the housing 40 (see FIGS. 2 and 3). As illustrated in FIG. 3, the metal terminal 10 has a rod shape extending straight in the front-rear direction as a whole, and specifically includes a small-diameter portion 11 located on a tip end side (front end side), a medium-diameter portion 12 located on a rear side of the small-diameter portion 11 and having a larger diameter than the small-diameter portion 11, and a large-diameter portion 13 located on a rear side (rear end side) of the medium-diameter portion 12 and having a larger diameter than the medium-diameter portion 12.

The small-diameter portion 11 is a part to be connected to the counterpart terminal belonging to the counterpart connector to be fitted to a hood portion 61 (see FIGS. 1 and 3) of the holder 60, and the medium-diameter portion 12 is a part to be held by a terminal holding portion 63 (see FIG. 3), which will be described later, of the holder 60. The large-diameter portion 13 is formed with, in a rear end surface thereof, a bolt hole (female screw hole) 14 recessed forward. The first busbar 20 is fastened and fixed to the rear end surface of the large-diameter portion 13 using the first metal bolt 81 screwed into the bolt hole 14 (see FIGS. 2 and 3).

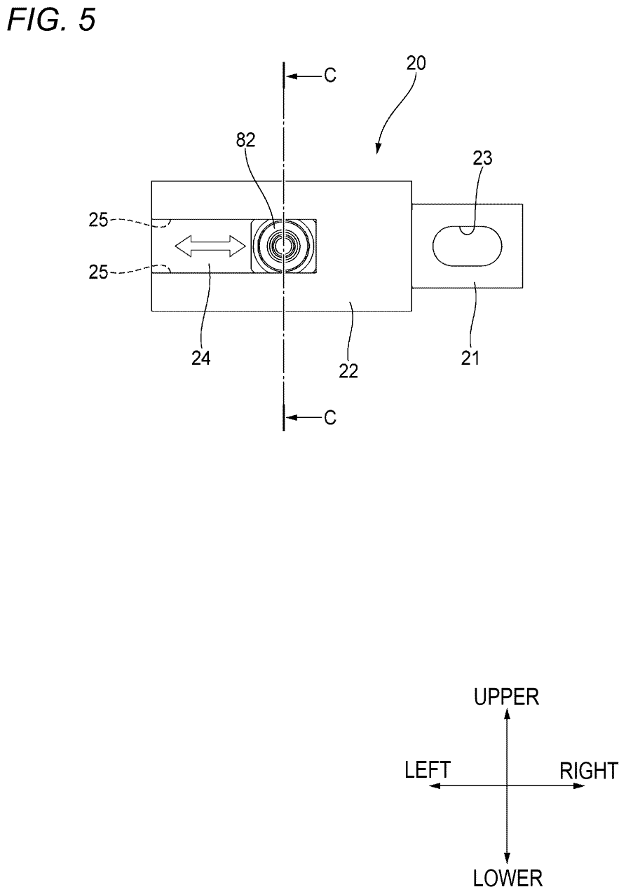

Next, the first busbar 20 will be described. The pair of left and right first busbars 20 respectively fastened to the pair of left and right terminals 10 are accommodated in the case 50 constituting the housing 40 in a state of being oriented in opposite directions in the left-right direction (see FIGS. 2, 3, and 5). As illustrated in FIGS. 2, 3, and 5, the first metal busbar 20 has a plate shape extending in the left-right direction as a whole, and specifically includes a fastening portion 21 located on an inner side in the left-right direction and a body portion 22 located on an outer side in the left-right direction.

The fastening portion 21 has a substantially rectangular flat plate shape extending in the left-right direction, and is formed with a first through hole 23 running in a plate thickness direction (front-rear direction) (see FIGS. 2, 3, and 5). Into the first through hole 23, a leg portion (male screw portion) of the first bolt 81 is inserted. The first through hole 23 has an elongated hole shape in which a hole width in the left-right direction is larger than a hole width in the upper-lower direction, so that a position of the first bolt 81 inserted into the first through hole 23 is adjustable in the left-right direction relative to the first through hole 23.

The body portion 22 has a plate thickness (thickness in the front-rear direction) larger than a plate thickness (thickness in the front-rear direction) of the fastening portion 21 and a plate thickness (thickness in the front-rear direction) of the second busbar 30, and has a substantially rectangular flat plate shape extending in the left-right direction. The body portion 22 having a larger plate thickness also has larger heat capacity. For this reason, the body portion 22 functions as a heat storage portion that actively absorbs heat generated in the first busbar 20 during energization. When the charging connector 1 is actually used, temperature (so-called operating temperature) of the terminal 10 rises due to Joule heat generated in the terminal 10 during energization. In this regard, heat transmitting to the first busbar 20 from the terminal 10 is absorbed by the body portion 22 (heat storage portion) even when an amount of heat generated in the terminal 10 per unit time is large as in fast charging, and thereby it is possible to prevent a rapid increase in the operating temperature of the terminal 10 and to gradually increase the operating temperature of the terminal 10.

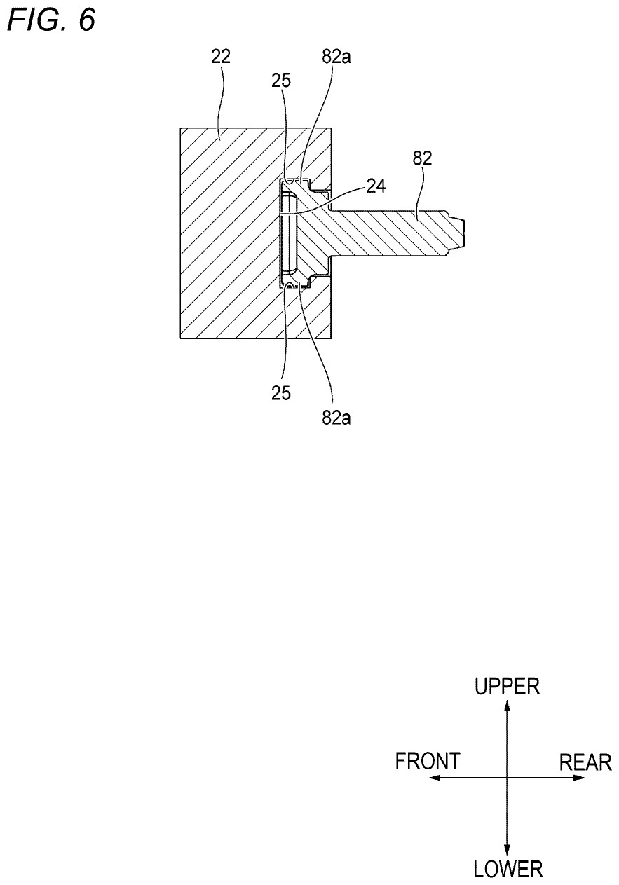

The body portion 22 is formed with, in a rear end surface thereof, a rail groove 24 that is recessed forward and extends in the left-right direction (see FIGS. 2, 3, and 5). The rail groove 24 is opened at an outer end thereof in the left-right direction. As illustrated in FIG. 6, the rail groove 24 is formed with, in a pair of upper and lower groove inner walls thereof, a pair of upper and lower recesses 25 that are recessed outward in the upper-lower direction and extend in the left-right direction. In the rail groove 24, the second bolt 82, whose leg portion (male screw portion) faces rearward, has a head portion thereof accommodated in a state in which protrusions 82a (see FIG. 6) of the head portion that are provided on an outer peripheral surface thereof are engaged with the pair of upper and lower recesses 25. Accordingly, the second bolt 82 is held in the rail groove 24 to be non-pivotable and slidable in the left-right direction in a state in which the leg portion (male screw portion) is exposed to an outside of the rail groove 24 and protrudes rearward. To the rear end surface of the body portion 22, the second busbar 30 is fastened and fixed using the second bolt 82 held in the rail groove 24 (see FIG. 3 and the like).

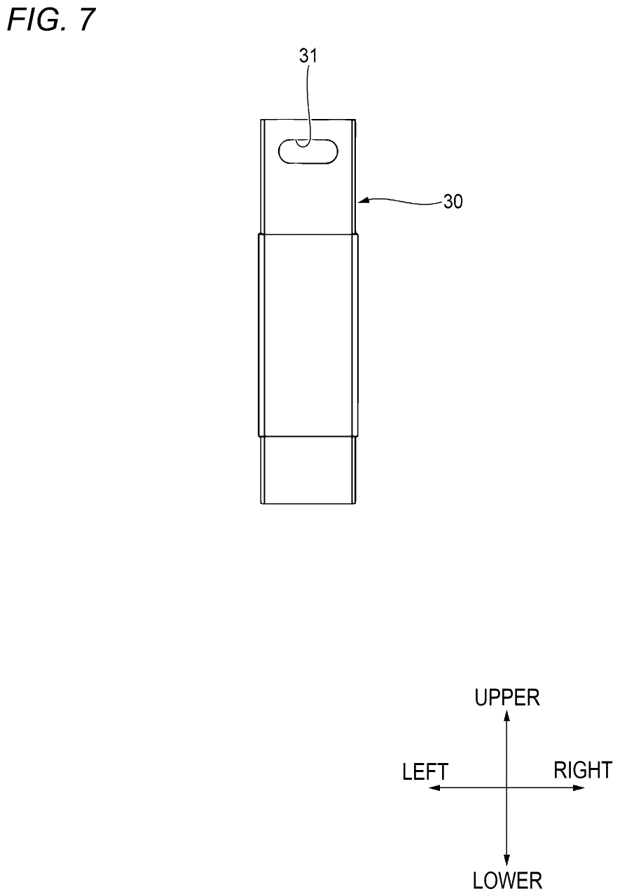

Next, the second busbar 30 will be described. The pair of left and right second busbars 30 respectively fastened to the pair of left and right first busbars 20 are inserted into a pair of left and right openings 41 (see FIGS. 1, 3, 4, and 7) that communicate an inside and an outside of the housing 40. As illustrated in FIGS. 2 and 7, the second metal busbar 30 has a flat plate shape extending straight in the upper-lower direction as a whole. The second busbar 30 is formed with, in an upper end portion thereof, a second through hole 31 running in the plate thickness direction (front-rear direction). Into the second through hole 31, the leg portion (male screw portion) of the second bolt 82 is inserted. The second through hole 31 has an elongated hole shape in which a hole width in the left-right direction is larger than a hole width in the upper-lower direction, so that the position of the second bolt 82 inserted into the second through hole 31 is adjustable in the left-right direction relative to the second through hole 31.

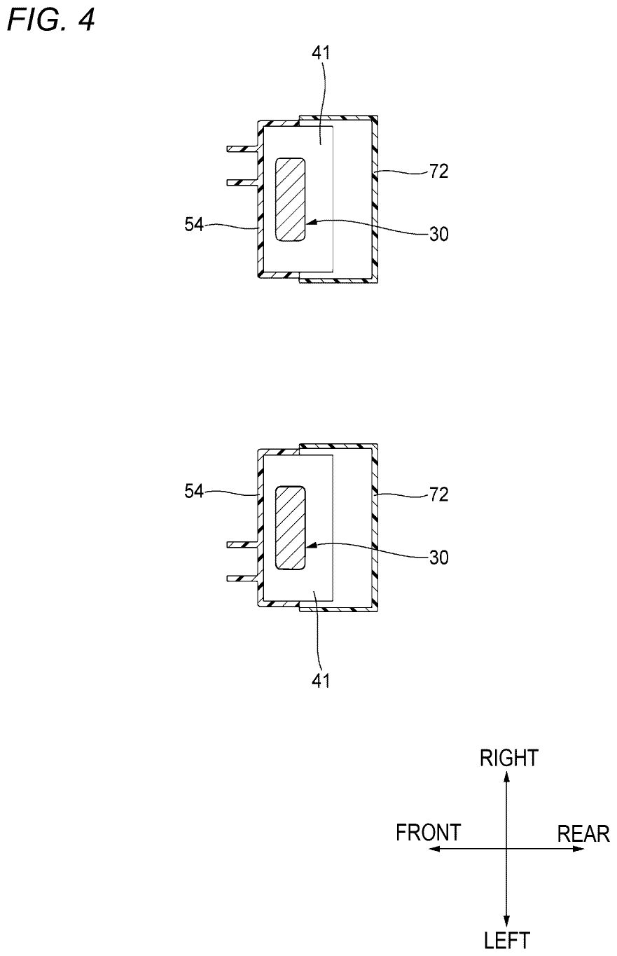

Next, the case 50 constituting the housing 40 will be described. The case 50 is a resin molded body, and as illustrated in FIGS. 2 and 3, includes a body portion 51 having a rectangular box shape elongated in the left-right direction. The body portion 51 has a front end thereof blocked by a front wall and a rear end opened. The body portion 51 is formed with, in a central portion of the front wall in the left-right direction, an opening (through hole) 52 through which the pair of left and right terminals 10 held by the holder 60 are inserted (see FIG. 3). The body portion 51 is provided with, at a central portion thereof in the left-right direction, a flat plate-shaped partition wall 53 extending in the upper-lower direction to divide an internal space of the body portion 51 elongated in the left-right direction into two in the left-right direction (see FIGS. 2 and 3). The body portion 51 is provided with, on a bottom wall (lower wall) thereof, a pair of left and right front peripheral wall portions 54 constituting front side parts of peripheral walls that define the pair of left and right openings 41 (see FIGS. 1 and 4) of the housing 40 that extend in the upper-lower direction. The pair of left and right front peripheral wall portions 54 extend downward from the bottom wall. A pair of left and right regions of the bottom wall of the body portion 51 surrounded by the pair of left and right front peripheral wall portions 54 are cut out to open in the upper-lower direction.

Next, the holder 60 constituting the housing 40 will be described. The holder 60 is assembled to the case 50 to block the opening 52 of the case 50. The holder 60 is a resin molded body and, as illustrated in FIGS. 1 and 3, includes the tubular hood portion 61 that has an opened front end and extends in the front-rear direction and a flat plate-shaped flange 62 that extends from a rear end of the hood portion 61 in the upper-lower and left-right directions. The hood portion 61 is a portion to which a counterpart connector is connected. As illustrated in FIG. 3, the hood portion 61 is formed with, on a rear wall that blocks the rear end thereof, a pair of left and right terminal holding portions 63. Specifically, each of the terminal holding portions 63 has a tubular shape extending in the front-rear direction and holds the medium-diameter portion 12 of the terminal 10 (see FIG. 3). An interval between the pair of left and right terminal holding portions 63 (that is, the pair of left and right terminals 10) is set to a value corresponding to a standard applied to the connector 1.

Next, the cover 70 constituting the housing 40 will be described. The cover 70 is assembled to the case 50 to block a rear end opening of the case 50. The cover 70 is a resin molded body and, as illustrated in FIGS. 2 and 3, includes a body portion 71 that has a rectangular box shape elongated in the left-right direction corresponding to the rear end opening of the case 50. The body portion 71 has a rear end thereof blocked by a rear wall and a front end opened. The body portion 71 is provided with, on a bottom wall (lower wall) thereof, a pair of left and right rear peripheral wall portions 72 constituting rear side parts of the peripheral walls that define the pair of left and right openings 41 (see FIGS. 1 and 4) of the housing 40 that extend in the upper-lower direction. The pair of left and right rear peripheral wall portions 72 extend downward from the bottom wall. A pair of left and right regions of the bottom wall of the body portion 71 surrounded by the pair of left and right rear peripheral wall portions 72 are cut out to open in the upper-lower direction. The members constituting the connector 1 are described above.

Next, an assembling procedure of the connector 1 will be described. To assemble the connector 1, first, the holder 60 in which the interval between the pair of left and right terminal holding portions 63 (that is, the pair of left and right terminals 10) is set to a value corresponding to a standard applied to the connector 1 is prepared, and the holder 60 is assembled to the case 50 from a front side (see FIG. 3). Specifically, the holder 60 is assembled to the case 50 such that the rear wall of the hood portion 61 blocks the opening 52 of the body portion 51 and the flange 62 comes into contact with the front wall of the body portion 51. In an assembled state of the holder 60, the pair of left and right terminal holding portions 63 face the opening 52.

Next, the pair of left and right terminals 10 are assembled to the holder 60 from a rear side. Specifically, each terminal 10 is inserted into the corresponding terminal holding portion 63 from the rear side, and the medium-diameter portion 12 is held by the corresponding terminal holding portion 63. In an assembled state of the pair of left and right terminals 10, the pair of left and right small-diameter portions 11 protrude forward from the pair of left and right terminal holding portions 63 and are located in an internal space of the hood portion 61, and the pair of left and right large-diameter portions 13 protrude rearward from the opening 52 and are located in an internal space of the body portion 51 with the partition wall 53 sandwiched in between from left and right (see FIG. 3). An order of assembling the holder 60 to the case 50 and assembling the terminal 10 to the holder 60 may be reversed.

Next, the pair of left and right first busbars 20 are respectively fastened to the pair of left and right terminals 10. Specifically, the leg portion of the first bolt 81 inserted into the first through hole 23 of the fastening portion 21 is screwed into the bolt hole 14 of the large-diameter portion 13 of the corresponding terminal 10 in a state in which the fastening portion 21 is located on the inner side in the left-right direction and extends in the left-right direction, and thereby each first busbar 20 is fastened to the corresponding terminal 10. At this time, the position of the first bolt 81 inserted into the first through hole 23 is adjustable in the left-right direction relative to the first through hole 23. Accordingly, by changing the position of the first bolt 81 in the left-right direction in the first through hole 23 according to an arrangement of the terminal 10, the terminal 10 and the first busbar 20 can be fastened without changing a shape of the first busbar 20 or a position of the first busbar 20 in the left-right direction in the case 50 even if the interval between the pair of left and right terminals 10 differs depending on the standard applied to the connector 1. Accordingly, the first busbar 20 can be shared even when the arrangement of the terminal 10 in the left-right direction differs. In a fastened state of the pair of left and right first busbars 20, the pair of left and right first busbars 20 are located in the internal space of the body portion 51 (see FIG. 3).

Next, the pair of left and right second busbars 30 are respectively fastened to the pair of left and right first busbars 20. Specifically, first, the head portion of the second bolt 82 is accommodated and held in the rail groove 24 of a corresponding one of the pair of left and right first busbars 20 via the opening of the rail groove 24 in the outer end in the left-right direction. Next, the leg portion of the second bolt 82 protruding from the rail groove 24 of the corresponding first busbar 20 is inserted through the second through hole 31 and fastened with a metal nut 83 in a state in which the second through hole 31 is located in the upper end portion and extends in the upper-lower direction, and thereby each second busbar 30 is fastened to the corresponding first busbar 20. At this time, a position of the second bolt 82 inserted into the second through hole 31 is adjustable in the left-right direction relative to the second through hole 31. Accordingly, by changing the position of the second bolt 82 in the left-right direction in the second through hole 31 according to an arrangement of the first busbar 20, the first busbar 20 and the second busbar 30 can be fastened without changing a shape of the second busbar 30 or a position of the second busbar 30 in the case 50 even if it is necessary to change the position of the first busbar 20 in the left-right direction according to the standard applied to the connector 1. Accordingly, the second busbar 30 can be shared even when the arrangement of the first busbar 20 in the left-right direction differs. Further, since the position of the second bolt 82 held in the rail groove 24 of the first busbar 20 is adjustable in the left-right direction relative to the rail groove 24, a degree of freedom in designing the position of the second busbar 30 in the left-right direction relative to the case 50 can be improved according to arrangements of other busbars, electric wires, and the like connected to a lower end portion of the second busbar 30. In a fastened state of the pair of left and right second busbars 30, each of the pair of left and right second busbars 30 is located in a space in the upper-lower direction that is defined by the corresponding front peripheral wall portion 54 of the case 50.

Next, the cover 70 is assembled to the case 50 from the rear side (see FIG. 3). Specifically, the cover 70 is assembled to the case 50 such that the body portion 71 blocks the rear end opening of the case 50 and the pair of left and right rear peripheral wall portions 72 are adjacent to respective rear sides of the pair of left and right front peripheral wall portions 54 to define the pair of left and right openings 41 (see also FIG. 4). In an assembled state of the cover 70, the housing 40 including the case 50, the holder 60, and the cover 70 is completed, and the pair of left and right second busbars 30 are inserted into the pair of left and right openings 41 communicating the inside and the outside of the housing 40 and extend downward from the pair of left and right openings 41 to the outside of the housing 40 (see FIG. 1). Therefore, the assembly of the connector 1 is completed, and the connector 1 illustrated in FIG. 1 is obtained.

The opening 41 (see FIG. 4) defined in the completed housing 40 has an opening width in the left-right direction that allows the second busbar 30 to be inserted therethrough both when the second bolt 82 is located at one end of the second through hole 31 in the left-right direction and when the second bolt 82 is located at the other end of the second through hole 31 in the left-right direction. Accordingly, even if it is necessary to change the position of the second busbar 30 in the housing 40, it is not necessary to prepare a dedicated housing 40 for each position of the second busbar 30. That is, the housing 40 can be shared.

### Operations and Effects

According to the connector 1 in the present embodiment as described above, the terminal 10 and the first busbar 20 are fastened by a first fastener (first bolt 81), and the first busbar 20 and the second busbar 30 are fastened by a second fastener (second bolt 82). The first through hole 23 of the first busbar 20 for inserting the first fastener 81 has an elongated hole shape elongated in a first direction (left-right direction), and the second through hole 31 of the second busbar 30 for inserting the second fastener 82 has an elongated hole shape elongated in a second direction (left-right direction). For this reason, even if the arrangement of the terminal 10 differs depending on the standard applied to the connector 1, by changing the position of the first fastener 81 in the first through hole 23 according to the arrangement of the terminal 10, the terminal 10 and the first busbar 20 can be fastened without changing the shape of the first busbar 20 or the position of the first busbar 20 in the housing 40. Even if it is necessary to change the position of the first busbar 20, by changing the position of the second fastener 82 in the second through hole 31 according to the arrangement of the first busbar 20, the first busbar 20 and the second busbar 30 can be fastened without changing the shape of the second busbar 30 or the position of the second busbar 30 in the housing 40. Therefore, the connector 1 according to the present embodiment can share the first busbar 20 and the second busbar 30 even if the arrangement of the terminal 10 differs.

Further, according to the connector 1 in the present embodiment, the opening 41 of the housing 40 has an opening width that allows the second busbar 30 to be inserted through the opening 41 both when the second fastener 82 is located at one end of the second through hole 31 and when the second fastener 82 is located at the other end of the second through hole 31. Accordingly, even if it is necessary to change the position of the second busbar 30 in the housing 40, it is not necessary to prepare a dedicated housing 40 for each position of the second busbar 30. That is, the housing 40 can be shared.

Further, according to the connector 1 in the present embodiment, the first busbar 20 includes a holding portion (rail groove 24) that slidably holds the second fastener 82. Accordingly, not only the position of the first busbar 20 and the position of the second busbar 30 but also the position of the second fastener 82 are adjustable, and thus the first busbar 20 and the second busbar 30 can be shared even if the arrangement of the terminal 10 differs, and a degree of freedom in designing the position of the second busbar 30 in the housing 40 can be improved.

Further, according to the connector 1 in the present embodiment, the pair of terminals 10 are arranged side by side in a direction in which the first through hole 23 of the first busbar 20 extends (that is, the first direction). Accordingly, even if the interval between the pair of terminals 10 differs depending on a standard, the terminals 10 and the first busbar 20 can be fastened without changing the shape of the first busbar 20 or the position of the first busbar 20 in the housing 40.

Further, according to the connector 1 in the present embodiment, the first busbar 20 includes a part having a plate thickness larger than the plate thickness of the second busbar 30 as a heat storage portion (body portion 22). Here, when the charging connector 1 is actually used, the temperature (so-called operating temperature) of the terminal 10 rises due to Joule heat generated in the terminal 10 during energization. Accordingly, an upper limit value or the like of the operating temperature of the terminal 10 may be determined by a prescribed standard in view of quality retention, safety, and the like of the connector 1. In the connector 1 according to the present embodiment, heat generated in the first busbar 20 during energization is absorbed by the heat storage portion 22 having a large heat capacity, and thereby it is possible to restrict a rapid increase in the operating temperature of the terminal 10 and to gently increase the operating temperature of the terminal 10 even when the amount of heat generated in the terminal 10 per unit time is large as in fast charging.

### OTHER EMBODIMENTS

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

In the above embodiment, since the first through hole 23 of the first busbar 20 has an elongated hole shape elongated in the left-right direction, the position of the first bolt 81 inserted into the first through hole 23 is adjustable in the left-right direction relative to the first through hole 23, and since the second through hole 31 of the second busbar 30 has an elongated hole shape elongated in the left-right direction, the position of the second bolt 82 inserted into the second through hole 31 is adjustable in the left-right direction relative to the second through hole 31. On the other hand, although the first through hole 23 of the first busbar 20 has an elongated hole shape elongated in the left-right direction so that the position of the first bolt 81 inserted into the first through hole 23 is adjustable in the left-right direction relative to the first through hole 23, the second through hole 31 of the second busbar 30 may have an elongated hole shape elongated in the upper-lower direction so that the position of the second bolt 82 inserted into the second through hole 31 is adjustable in the upper-lower direction relative to the second through hole 31.

Here, features of the embodiment of the connector 1 according to the present disclosure described above are briefly summarized and listed in following [1] to [5].

### First Aspect

A connector (1) includes a terminal (10), a first busbar (20) configured to be connected to the terminal (10), a first fastener (81) configured to fasten the terminal (10) and the first busbar (20), a second busbar (30) configured to be connected to the first busbar (20), a second fastener (82) configured to fasten the first busbar (20) and the second busbar (30), and a housing (40) configured to accommodate the terminal (10). The first busbar (20) has a first through hole (23) through which the first fastener (81) is configured to be inserted. The second busbar (30) has a second through hole (31) through which the second fastener (82) is configured to be inserted. The first through hole (23) has an elongated hole shape in which a hole width in a prescribed first direction is larger than a hole width in a direction intersecting the first direction, and allows a position of the first fastener (81) in the first through hole (23) to be adjustable in the first direction. The second through hole (31) has an elongated hole shape in which a hole width in a prescribed second direction is larger than a hole width in a direction intersecting the second direction, and allows a position of the second fastener (82) in the second through hole (31) to be adjustable in the second direction.

According to the connector having the configuration of the first aspect, the terminal and the first busbar are fastened by the first fastener, and the first busbar and the second busbar are fastened by the second fastener. The first through hole of the first busbar for inserting the first fastener has an elongated hole shape elongated in the first direction, and the second through hole of the second busbar for inserting the second fastener has an elongated hole shape elongated in the second direction. For this reason, even if the arrangement of the terminal differs depending on a standard applied to the connector, by changing the position of the first fastener in the first through hole according to the arrangement of the terminal, the terminal and the first busbar can be fastened without changing the shape of the first busbar or the position of the first busbar in the housing. Even if it is necessary to change the position of the first busbar, by changing the position of the second fastener in the second through hole according to the arrangement of the first busbar, the first busbar and the second busbar can be fastened without changing the shape of the second busbar or the position of the second busbar in the housing. Therefore, the connector having the present configuration can share the internal busbars even if the arrangement of the terminal differs.

### Second Aspect

In the connector (1) according to the first aspect, the housing (40) has an opening (41) through which the second busbar (30) is configured to be inserted into and out of the housing (40). The opening (41) has an opening width in the second direction that allows the second busbar (30) to be inserted through the opening (41) both when the second fastener (82) is located at one end of the second through hole (31) and when the second fastener (82) is located at the other end of the second through hole (31).

According to the connector having the configuration of the second aspect, the opening of the housing has an opening width that allows the second busbar to be inserted through the opening both when the second fastener is located at one end of the second through hole and when the second fastener is located at the other end of the second through hole. Accordingly, even if it is necessary to change the position of the second busbar in the housing, it is not necessary to prepare a dedicated housing for each position of the second busbar. That is, the housing can be shared.

### Third Aspect

In the connector (1) according to the third aspect, the first busbar (20) includes a holding portion (24) that is configured to hold the second fastener (82) such that the second fastener (82) is slidable in the second direction.

According to the connector having the configuration of the third aspect, the first busbar includes a holding portion that slidably holds the second fastener. Accordingly, not only the position of the first busbar and the position of the second busbar but also the position of the second fastener are adjustable, and thus the internal busbars can be shared even if the arrangement of the terminal differs, and a degree of freedom in designing the position of the second busbar in the housing can be improved.

### Fourth Aspect

In the connector (1) according to the first aspect, a pair of the terminals (10) are configured to be arranged side by side in the first direction.

According to the connector having the configuration of the fourth, the pair of terminals are arranged side by side in the direction in which the first through hole of the first busbar extends (that is, the first direction). Accordingly, even if the interval between the pair of terminals differs depending on a standard, the terminals and the first busbar can be fastened without changing the shape of the first busbar or the position of the first busbar in the housing.

### Fifth Aspect

In the connector (1) according to the first aspect, at least a part of the first busbar (20) has a plate thickness larger than a plate thickness of the second busbar (30). The at least a part of the first busbar (20) is configured to function as a heat storage portion (22).

According to the connector having the configuration of the fifth aspect, the first busbar includes a part having a plate thickness larger than the plate thickness of the second busbar as the heat storage portion. Here, when the charging connector is actually used, the temperature (so-called operating temperature) of the terminal rises due to Joule heat generated in the terminal during energization. Accordingly, an upper limit value or the like of the operating temperature of the terminal may be determined by a prescribed standard in view of quality retention, safety, and the like of the connector. In the connector 1 having the present configuration, heat generated in the first busbar during energization is absorbed by the heat storage portion having a large heat capacity, and thereby it is possible to restrict a rapid increase in the operating temperature of the terminal and to gently increase the operating temperature of the terminal even when the amount of heat generated in the terminal per unit time is large as in fast charging.

What is claimed is:

1. A connector comprising:
a terminal;
a first busbar configured to be connected to the terminal;
a first fastener configured to fasten the terminal and the first busbar;
a second busbar configured to be connected to the first busbar;
a second fastener configured to fasten the first busbar and the second busbar; and
a housing configured to accommodate the terminal,
wherein the first busbar has a first through hole through which the first fastener is configured to be inserted,
wherein the second busbar has a second through hole through which the second fastener is configured to be inserted,
wherein the first through hole has an elongated hole shape in which a hole width in a prescribed first direction is larger than a hole width in a direction intersecting the first direction, and allows a position of the first fastener in the first through hole to be adjustable in the first direction, and
wherein the second through hole has an elongated hole shape in which a hole width in a prescribed second direction is larger than a hole width in a direction intersecting the second direction, and allows a position of the second fastener in the second through hole to be adjustable in the second direction.

2. The connector according to claim 1,
wherein the housing has an opening through which the second busbar is configured to be inserted into and out of the housing, and
wherein the opening has an opening width in the second direction that allows the second busbar to be inserted through the opening both when the second fastener is located at one end of the second through hole and when the second fastener is located at the other end of the second through hole.

3. The connector according to claim 1,
wherein the first busbar includes a holding portion that is configured to hold the second fastener such that the second fastener is slidable in the second direction.

4. The connector according to claim 1,
wherein the pair of terminals are configured to be arranged side by side in the first direction.

5. The connector according to claim 1,
wherein at least a part of the first busbar has a plate thickness larger than a plate thickness of the second busbar, and
wherein the at least a part of the first busbar is configured to function as a heat storage portion.
